(19) United States
(12) Patent Application Publication
(10) Pub. No.: US 2014/0333030 A1
(43) Pub. Date: Nov. 13, 2014

(54) APPARATUS HAVING AT LEAST ONE PASSAGE FOR CONDUCTING A GASEOUS OR A LIQUID OPERATING MEDIUM

(71) Applicant: Pfeiffer Vacuum GmbH, Asslar (DE)

(72) Inventors: Herbert Stammler, Giessen (DE); Soenke Gilbrich, Greifenstein (DE)

(73) Assignee: Pfeiffer Vacuum GmbH, Asslar (DE)

(21) Appl. No.: 14/272,541

(22) Filed: May 8, 2014

(30) Foreign Application Priority Data
May 10, 2013 (DE) 102013208614.8

(51) Int. Cl. F16J 15/02

(52) U.S. Cl. CPC F16J 15/021
USPC 277/312; 277/641

(57) ABSTRACT

An apparatus having at least one passage for conducting a gaseous or a liquid operating medium, in particular a vacuum pump, wherein the passage is closed in a fluid-tight manner at a side by at least one elongate sealing element following the extent of the passage. A method of manufacturing an apparatus having at least one passage for conducting a gaseous or a liquid operating medium includes providing a component with a passage-forming groove.

### BACKGROUND OF THE INVENTION

1. Field of the Invention

The invention relates to an apparatus having at least one passage for conducting a gaseous or a liquid operating medium, in particular in a vacuum pump. The invention furthermore relates to a method of manufacturing an apparatus having at least one passage for conducting a gaseous or a liquid operating medium.

2. Description of the Prior Art

The operation of many technical devices such as the operation of vacuum pumps requires the use of a gaseous or of a liquid operating medium and a direct and controlled conducting of the operating medium within the device. For example, the energy-efficient operation of a vacuum pump can require the constant supply of a roller element bearing of the vacuum pump with a lubricant. Such technical devices therefore comprise an apparatus having a first component and a second component which form a passage for conducting the gaseous or the liquid operating medium. A groove whose longitudinal extent corresponds to the desired passage extent is provided in a side of the first component for this purpose. The second component is connected to the first component and covers the side of the first component having the groove over the full area in the manner of a cover so that the groove is closed by the second component to form the passage.

To close the groove reliably, the second component has to be designed exactly complementary to the first component over the total surface which covers the side of the first component in which the groove is formed and must be exactly correctly positioned relative to the first component and be fixed to it.

The requirement of the highly precise adaptation of the two components to one another reduces the permitted manufacturing tolerances and increases the complexity of the manufacture and assembly of such an apparatus. The manufacture and assembly of the apparatus is therefore associated with a high time effort and cost effort.

It is an object of the invention to provide an apparatus having at least one passage for conducting a gaseous or a liquid operating medium which can be manufactured with a reduced effort as well as to provide a method of manufacturing an apparatus having at least one passage for conducting a gaseous or a liquid operating medium which can be carried out with a reduced effort.

### SUMMARY OF THE INVENTION

The object of the invention is achieved by an apparatus comprising at least one passage for conducting a gaseous or a liquid operating medium, in particular in a vacuum pump. The passage is closed in a fluid-tight manner at a side by at least one elongate sealing which follows the extent of the passage.

Instead of a component of a cover type which covers a component having a groove for the passage over its total side having the groove, an elongate sealing element is therefore used which follows the extent of the passage. It is thus not necessary to manufacture a component of a cover type which is configured exactly complementary to another component over the total side of this other component having the groove. Instead, a suitable sealing element is only arranged in the region of the passage itself, i.e. directly where a sealing effect is required. The provision and assembly of such a sealing element is possible with a small effort so that the effort required for the manufacture of the apparatus is considerably reduced.

Advantageous embodiments of the invention are described in the dependent claims, in the description and in the Figures.

In accordance with an embodiment, the sealing element is configured as elastically deformable at least regionwise and/or the sealing element is configured as plastically deformable at least regionwise. The manufacture of the apparatus is thereby even further facilitated since no sealing element has to be manufactured which exactly corresponds to the shape of the passage opening to be sealed, but the sealing element can rather instead be elastically and/or plastically deformed in the course of manufacture such that it adopts the required shape.

The passage preferably has a closed cross-section at least regionwise. An unwanted exit of the operating medium from the passage is thereby prevented. The passage can have a closed cross-section over its total length or over at least over approximately its total length.

In accordance with an embodiment, the sealing element is formed by a separate sealing element which bounds the passage together with a component of the apparatus. The separate sealing element can be added to the component as a prefabricated element. The separate sealing element can also be formed by a sealing material which e.g. contains silicone and which was added to the component in a flowable state and was thereupon solidified or hardened to form the sealing element.

The component preferably has a groove, with at least a region of the groove being closed by the sealing element and with the passage being formed by the closed region of the groove and being bounded in a fluid-tight manner by the groove wall and the sealing element. A simple design and a simple manufacturing capability of the apparatus are thereby achieved.

Provision is made in accordance with an embodiment that the sealing element is arranged within the groove at least regionwise. In this respect, a particularly stable and sealing connection can be provided in a simple manner between the component and the sealing element by a corresponding cooperation with the groove wall. The passage can be formed by a part region of the groove, whereas another part region of the groove receives the sealing element. The sealing element can be arranged completely within the groove at least longitudinally sectionally or over its total length. A protected arrangement of the sealing element is thereby ensured.

A further embodiment provides that the sealing element covers the groove opening at least regionwise. The sealing element can completely cover the groove opening at least longitudinally sectionally, with the passage being able to comprise the total groove interior over the corresponding groove length.

In accordance with an embodiment, the sealing element is connected to the groove wall and/or to the groove margin, in particular at both sides of the groove. A sealing element connected to the groove wall can be arranged within the groove at least regionwise. A sealing element connected to the groove margin can cover the groove opening at least regionwise. The connection between the sealing element and the groove wall and/or the groove margin can, for example, have material continuity, be force-transmitting and/or form-fitted, with the force-transmitting connection being able to be a friction-locking connection. The sealing element is preferably connected in a fluid-tight manner to the groove wall and/or to the groove margin.

A connection with material continuity between the component and the sealing element can be formed, for example, by an adhesively acting connection or by a weld connection. The sealing element can, for example, be connected to the component by an additional adhesive or the sealing element can itself directly enter into an adhesively acting connection with the component.

A force-transmitting connection can be formed in that the sealing element and the component contact one another under a preload, with the preload preferably being caused by an elastic deformation of the sealing element and/or of the component by the respective other element. The sealing element can in this respect have oversize with respect to a receiver of the component in which the sealing element is arranged. The sealing element is preferably jammed with the component or is clamped in a receiver of the component.

In accordance with an advantageous embodiment, the sealing element is clamped in the groove at least regionwise. A force-transmitting connection can thereby be provided between the sealing element and the component which is simple to manufacture and both mechanically particularly solid and fluid tight. The sealing element can be in force-transmitting contact with the groove wall at both sides of the groove.

A form-fitted connection can be effective simultaneously in all directions or at least in all directions orientated perpendicular to the longitudinal extent of the passage. The form-fitted connection is preferably at least active in the direction facing from the groove interior toward the groove opening of the passage to prevent an unwanted removal of the sealing element from the component in this direction. To form the form-fitted connection, the sealing element can form an undercut with the component which is effective in the respective direction or in the respective directions.

In accordance with an advantageous embodiment, the component has at least one cut-out which is formed in the groove wall and into which the sealing element engages. A form-fitted connection can thereby be provided between the sealing element and the component which is in particular effective in the direction from the groove interior to the groove opening and prevents a removal of the sealing element in this direction. The cut-out can be formed at both sides of the groove and the sealing element can engage into the cut-out at both sides of the groove.

The sealing element can be connected to the component by a force-transmitting and simultaneously form-fitted connection. For example, the sealing element can engage into a cut-out of the component formed in the groove wall and can simultaneously be in force-transmitting contact with the section of the groove wall forming the cut-out.

The sealing element can be elastically and/or plastically deformable or can comprise or consist of an elastically and/or plastically deformable material. An elastically deformable sealing element can e.g. be in contact with the component and can be elastically deformed by the component while forming a force-transmitting connection as described above. An elastic and/or plastic deformability also facilitates the manufacture of a form-fitted connection as described above between the sealing element and the component. The sealing element can then e.g. be introduced through the groove opening into the groove of the component in a first shape state or deformation state and can subsequently adopt a second deformation state by elastic restoration or plastic deformation in that it forms an undercut with the component which is active e.g. in the direction toward the groove opening.

The sealing element can comprise or be composed of a plastic, in particular an elastically deformable plastic, such as an elastomeric plastic. The sealing element can also comprise or consist of a metallic material which is preferably elastically and/or plastically deformable.

In accordance with an embodiment, the sealing element has a circular cross-sectional shape, an oval cross-sectional shape, a cross-sectional shape closed in ring shape or an elongated cross-sectional shape at least over a part of its length perpendicular to its longitudinal direction. These cross-sectional shapes are particularly well-suited for an elastic and/or a plastically deformable embodiment of the sealing element or for forming a force-transmitting and/or form-fitted connection of the sealing element to the component.

In accordance with an embodiment, the sealing element is formed by an O ring, by a sealing strip, by a pipe or by a sheet metal section. An O ring is a particularly suitable and inexpensively available sealing element. The 0 ring can be configured as closed in ring shape. An O ring or a section of an O ring cut through transversely to its longitudinal extent can also be used which is not closed in ring shape, but is rather e.g. configured as ring segment-shaped. A sealing strip is a sealing element having two longitudinal ends which is particularly suitable for closing elongated passages with free longitudinal ends. The sealing strip can have a small bending stiffness. This has the advantage that the sealing strip does not have to be prefabricated in a shape corresponding to the longitudinal shape of the passage, but can rather be adapted to the passage extent in the manufacture of the apparatus without any great effort by a corresponding bending or twisting, for example in that the sealing strip is inserted into the groove forming the passage.

The O ring or the sealing strip can have an at least approximately circular, oval, circular-ring shaped or oval-ring shaped cross-section. The O ring or the sealing strip can be formed from a plastic, in particular from an elastomeric plastic, or from another elastic material.

A tube or a sheet metal section can comprise or consist of a metal material which is preferably plastically deformable. A sheet metal section is understood as a planar section having any desired elongated cross-section shape. Such a sheet metal section can be plastically deformed particularly strongly due to its elongated cross-section. A tube or a sheet metal section having a U-shaped cross-section or another spatial sheet metal section can be used, for example.

The sealing element can also be formed by a sealing material which has become solid or has hardened, which is e.g. arranged regionwise in the passage and/or which covers the opening of the groove of the component at least regionally and, preferably, is connected to the groove margin at both sides of the groove. The sealing element can also be an elastically deformable self-adhesive sealing element such as an adhesive band which is, for example, adhered to the groove margin, in particular at both sides of the groove, and covers the groove opening completely.

A further advantageous embodiment provides that the sealing element is formed by wall sections of a component bounding the passage which are brought into contact with one another by deformation. The sealing element is therefore not formed by a separate sealing element, but rather by sections of the actual component bounding the passage which are brought into contact with one another, with the wall sections preferably adjoining the regions of the component bounding the passage with unity of material. The provision of the sealing element thus does not require the provision and installation of a separate sealing element. The wall sections can contact one another under a preload which can be caused by an elastic deformation of the component to ensure a particularly reliable and sealing closure of the passage.

The sealing element and/or the passage can be configured in ring shape. A ring-shaped passage is desirable in many applications to ensure a ring-shaped conducting of the operating medium. A ring-shaped sealing element is suitable for sealing such a ring-shaped passage. A separate ring-shaped sealing element such as an O ring can moreover be substantially loaded in tension in its longitudinal direction and can achieve a particularly high sealing effect with a force-transmitting connection of the sealing element to the component provided by an elastic deformation of the sealing element. A ring-shaped sealing element is consequently also advantageous when the passage has at least one longitudinal end.

In accordance with an embodiment, the passage has at least one longitudinal end at which the passage is preferably closed in a fluid-tight manner by the sealing element. Even if an inlet and/or an outlet of the passage is provided at the longitudinal end, for example as a pick-up and/or as a deviation for the operating medium, it is preferred if the passage is closed in a fluid-tight manner by the sealing element at the longitudinal end and if the sealing element is not interrupted for forming the inlet or outlet respectively. Instead, the inlet or outlet respectively can be formed by an opening of the component which is independent of the sealing element and which opens into the passage, for example a lateral bore of the component. If the passage is formed by a groove of the component, a geometry can be provided at the respective longitudinal end which narrows or ends the groove and which closes the passage in a fluid-tight manner with the aid of the sealing element.

In accordance with an embodiment, the apparatus is a vacuum pump or a component of a vacuum pump. The invention accordingly also comprises a vacuum pump formed by the apparatus or a vacuum pump comprising the apparatus. It has been found that the apparatus is exceptionally suited for conducting an operating medium in a vacuum pump since it can be inexpensively manufactured, can be configured as vacuum-compatible and has a particular high leak tightness and mechanical and thermal resistance.

The operating medium can e.g. be a lubricant, a coolant such as cooling water, a barrier gas, a venting gas or a process gas, in particular if the apparatus is a vacuum pump or a component of a vacuum pump. The passage is preferably at least partly filled with the operating medium. The sealing element seals the passage in a fluid-tight manner so that an escape of the operating medium through the sealing element is prevented.

The passage can serve e.g. for conducting a lubricant which can be supplied to a rotary bearing, in particular to a roller element bearing, which e.g. rotatably assists a rotor shaft of a vacuum pump. The passage can be a part of a lubricant circuit for conducting the lubricant to the rotary bearing and back. The passage can e.g. be in ring shape about the axis of rotation of a rotor shaft and in particular substantially rotationally symmetrical to the axis of rotation. The passage can e.g. have a supply section or can open into a supply passage which conducts the lubricant to a conical section of the rotor shaft which is configured to convey the liquid lubricant provided from the passage by the capillary action of the lubricant and by the centrifugal force acting on the rotation of the shaft.

The component bounding the passage is preferably substantially disk-shaped. The side of the passage closed by the sealing element preferably faces a flat side of the disk-shaped component. The sealing element preferably extends only over a part of the base surface of the flat side, namely preferably substantially only over the region in which the passage is formed. If the sealing element is formed by a separate sealing element, it is preferred if the component partly or completely, and in particular in at least its region bounding the passage, comprises a material which is harder and/or less elastic than a material of the sealing element. The passage can generally comprise at least partly or completely, and in particular in at least its region bounding the passage, a metallic material. The component can be in one part or in multiple parts.

The apparatus can comprise a plurality of different sealing media which preferably close different longitudinal sections of the passage, with each sealing element respectively being able to be formed in accordance with the above description.

A further subject of the invention is a method of manufacturing an apparatus having at least one passage for conducting a gaseous or a liquid operating medium which comprises a component being provided which has a groove and the groove opening being closed in a fluid-tight manner to form the passage by an elongated sealing element following the extent of the groove. An apparatus in accordance with the invention according to the present description can be manufactured using the method. The advantages and advantageous embodiments described in this description with respect to the apparatus in accordance with the invention and its manufacture represent corresponding advantages and advantageous embodiments of the method. To provide the component, a groove can be introduced into an original component, for example by a material removing process, in particular by a cutting process, such as milling or lathing.

In accordance with an embodiment, the component is provided with a separate sealing element or with a sealing material which is solidified to form a separate sealing element. The sealing element or the sealing material can be connected to the component with material continuity, with force-transmission and/or with form fit. The sealing element can be introduced into the groove at least regionwise, and indeed preferably through the groove opening extending in the longitudinal direction of the groove.

In accordance with an embodiment, the component is provided with a sealing material which enters into an adhesively active connection with material continuity with the component and is solidified or hardened for form the sealing element, with the sealing material e.g. being able to contain silicone. The sealing material can be introduced at least regionwise into the groove and/or can be applied to the groove margin such that it at least regionally covers the groove opening. A prefabricated sealing element can be adhesively bonded to the component to form a connection with material continuity. For example, an elastically deformable self-adhesive sealing element such as an adhesive band can be used which is e.g. adhered to the groove margin, in particular at both sides of the groove, so that it covers the groove opening at least regionwise. The elastically deformable sealing element automatically matches the topography of the groove margin on the adhesive bonding so that the manufacture of the apparatus is extremely simply possible.

The sealing element and/or the component can be elastically and/or plastically deformed during the manufacture, in particular to establish a force-transmitting or form-fitted connection between the sealing element and the component. For this purpose, an application of force or pressure onto the sealing element can take place and the sealing element and the component can be tensioned or clamped to one another. The sealing element can be pressed into the groove and/or clamped in the groove.

To establish a force-transmitting connection, the sealing element can e.g. be elastically deformed and can be coupled to the component and brought into contact with the component in an elastically deformed state or under an elastic preload. The sealing element can, for example, be clamped in the groove in an elastically deformed state. A plastic deformation of the sealing element can also take place for establishing a force-transmitting connection. For example, the sealing element can for this purpose be pressed toward the component such that the sealing element is plastically deformed at the component and the component simultaneously at least slightly yields to the sealing element and is elastically deformed. This can take place such that, after the pressure application, the elastic restoring force or the springing back of the component, the plastically deformed sealing element is clamped and is in this respect elastically deformed such that the component and the sealing element are connected to one another in a force-transmitting manner. For this purpose, the sealing element can e.g. be introduced into the groove and pressed with the groove wall such that the sealing element is subsequently clamped in the groove. The sealing element can in this respect at least partly comprise a metallic material and/or can be formed by a tube or by a sheet metal section which is plastically deformable. The sheet metal section can be spread apart in the course of the pressing in that mutually oppositely disposed limbs of the sheet metal section are pressed apart.

For example, a tube or a substantially U-shaped sheet metal section can be placed into the groove, with the apex of the U-shaped cross-section facing in the direction of the groove base. The tube or the sheet metal section can then be pressed with the component from outside the groove, with the tube or the U-shaped section being pressed in an angular manner after the pressing at its upper side arranged in the region of the groove opening and/or is supported laterally with respect to the groove wall.

The establishing of a form-fitted connection between the sealing element and the component can comprise a deformation of the sealing element or of the component. The sealing element can e.g. be plastically deformed such that the plastically deformed sealing element forms a desired undercut with the component. The sealing element can also be coupled to the component in an elastically deformed state so that the elastic restoration or the spring back of the sealing element produces the desired undercut.

The sealing element can, for example, be introduced at least regionally into the groove and can then be plastically deformed such that it engages into a cut-out of the component provided in the groove wall. The sealing element can equally have oversize with respect to the groove opening and can be introduced into the groove through the groove opening under elastic deformation, with the following elastic springing back of the sealing element producing an engagement of the sealing element into a cut-out arranged behind the groove opening. The method can also be carried out such that a connection is provided between the sealing element and the component by an elastic deformation of the sealing element and/or of the component, the connection having both material continuity and a form fit For example, the sealing element can be introduced into the groove such that it engages into a cut-out of the component provided in the groove wall and contacts the section of the groove wall forming the cut-out under elastic preload.

As described above, both the establishing of a force-transmitting connection and the establishing of a form-fitted connection between the sealing element and the component can comprise a plastic and/or elastic deformation of the sealing element and/or of the component. An elastic deformation can take place with a lower force effort and requires that the sealing element and the component are sufficiently exactly matched to one another such that the respective connection can be established within the framework of the respective elastic deformability. On a plastic deformation, higher forces are required as a rule, with a less exact matching of the sealing element and of the component to one another being able to be permitted since any deviations can be compensated by a substantial plastic deformation.

In accordance with a further embodiment, wall sections of the component are brought into contact with one another by deformation to form the sealing element. The deformation preferably takes place plastically and elastically so that the plastically deformed wall sections contact one another in a fluid-tight manner under an elastic preload.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

FIG. 1 a cross-sectional view of the inventive apparatus as a vacuum pump in accordance with an embodiment of the invention;

FIG. 2 a view of the section A of FIG. 1 at an enlarged scale;

FIGS. 3 and 4 cross-sectional views of respective apparatuses in accordance with further embodiments of the invention;

FIG. 5 a cross-sectional view of a component for use in a method in accordance with an embodiment of the invention; and

FIG. 6 a cross-sectional view of the apparatus manufactured from the component of FIG. 5.

### DETAILED DESCRIPTION OF THE PREFERRED EMBODIMENTS

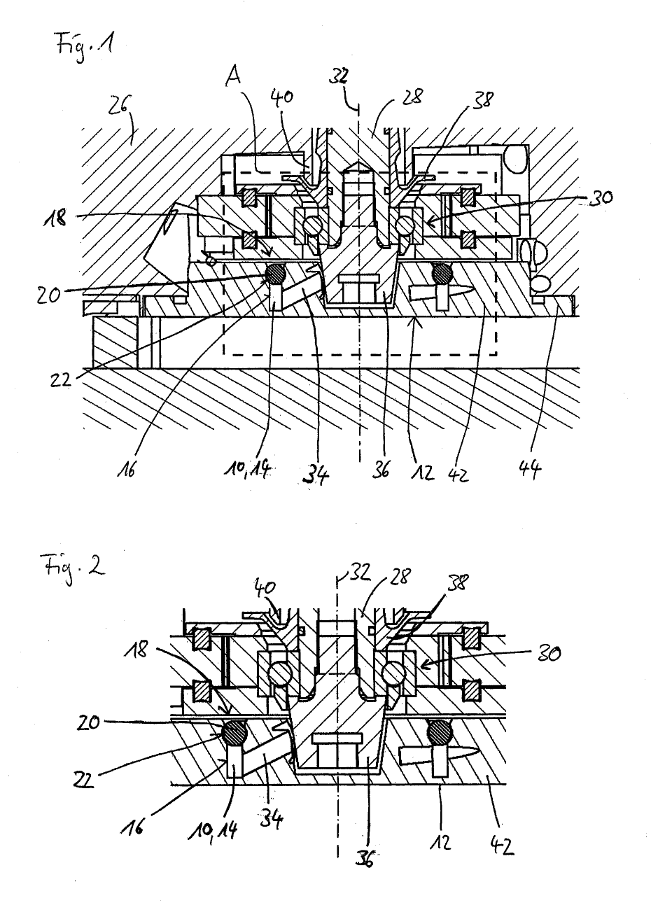

FIG. 1 shows a vacuum pump having a housing 26 in which a rotor shaft 28 is rotatably supported about an axis of rotation 32 by a roller element bearing 30. The vacuum pump comprises a component 12 which closes, in the manner of a cover, a hollow space of the housing 26 receiving the roller element bearing 30. The component 12 comprises a main section 42 in the form of circular disk shape and a collar section 44 which projects radially from the main section 42 and via which the component 12 is fastened to the housing 26.

The main section 42 of the component 12 has a groove 14 which is open toward the flat side of the main section 42 facing the roller element bearing 30 and which extends in ring form about the axis of rotation 32. The groove 14 is closed in a fluid-tight manner from the side 18 of the groove opening by a sealing element 20 so that the region of the groove 14 remote from the groove opening forms a passage 10 which is bounded by the groove wall 16 and by the sealing element 20 and in which a lubricant is received which is not shown in FIGS. 1 and 2. The sealing element 20 is formed by an elastomeric O ring.

Since the groove 14 is narrower in the region of its opening than the sealing element 20, the O ring is elastically deformed on the manufacture of the apparatus and is pressed through the groove opening into the groove 14. To facilitate the introduction of the O ring, the groove 14 has a cross-section in the region of its opening which tapers from the groove opening into the groove. In the direction of insertion after the tapering, the groove wall 16 forms a cut-out 22 at both sides of the groove 14 and the O ring 20 comes to lie in said cut-out such that it forms an undercut with the groove wall 16 which is active in the direction toward the groove opening and which prevents an unintended removal of the O ring 20 from the groove 14. The O ring 20 has oversize with respect to the groove 14 in the region of the cut-out 22 so that the O ring 20 is permanently elastically deformed by the groove wall 16. The elastic restoring force of the O ring 20 effects a preloading of the O ring 20 with respect to the groove wall 16 which effects a sealing and force-transmitting contact of the O ring 20 at the groove wall 16.

A supply passage 34 is formed in the main section 42 and connects the passage 10 in a fluid-tight manner to the outer side of the component 12 and serves as a pick-up for the lubricant. A conical section 36 of the rotor shaft 28 whose diameter becomes larger in the axial direction toward the roller element bearing 30 is arranged at a small spacing from the end of the supply passage 34. The lubricant conducted in the passage 10 moves through the supply passage 34 to the conical section 36 of the rotor shape 28 and is taken up by it by a capillary action and is conveyed as a result of the centrifugal force acting on the operation of the vacuum pump following the diameter of increasing size of the conical section 36 to the roller element bearing 30, where it satisfies its lubricating function.

The lubricant moves through the roller element bearing 30 in an axial direction to a conveying collar 38 which is arranged at the rotor shaft 28, which projects radially from the rotor shaft 28 and which has an outer diameter increasing in size in the axial direction away from the roller element bearing 30 so that the lubricant is conveyed away from the roller element bearing 30 as a result of the capillary action and of the centrifugal force acting on operation of the vacuum pump. At its end, the conveying collar has a section which extends substantially in the horizontal direction and which is oppositely disposed at a small spacing from a static section of the pump which transfers the lubricant back to the static part of the pump by a capillary action. From there, the lubricant is conducted back into the passage 10 in a manner not shown in any more detail so that the passage 10 forms a part of a lubricant circuit.

The housing 26 has a prolongation 40 of pipe-socket shape which projects in the axial direction and which engages behind the conveying collar 38 and forms a narrow gap with it to seal the pump components disposed on the other side of the prolongation 40 with respect to the lubricant circuit.

FIG. 3 shows an apparatus in accordance with an embodiment of the invention in a representation sectioned perpendicular to the longitudinal direction of the passage 10. The apparatus comprises a disk-shaped component 12 in which a groove 14 is formed which is open along its longitudinal extent at a side 18. The groove 14 is closed in a fluid-tight manner to form the passage 10 by a sealing element 20 which is formed in the present embodiment by a self-adhesive adhesive band which is adhesively bonded to the margin of the groove 14 at both sides and which covers the opening of the groove 14 at both sides.

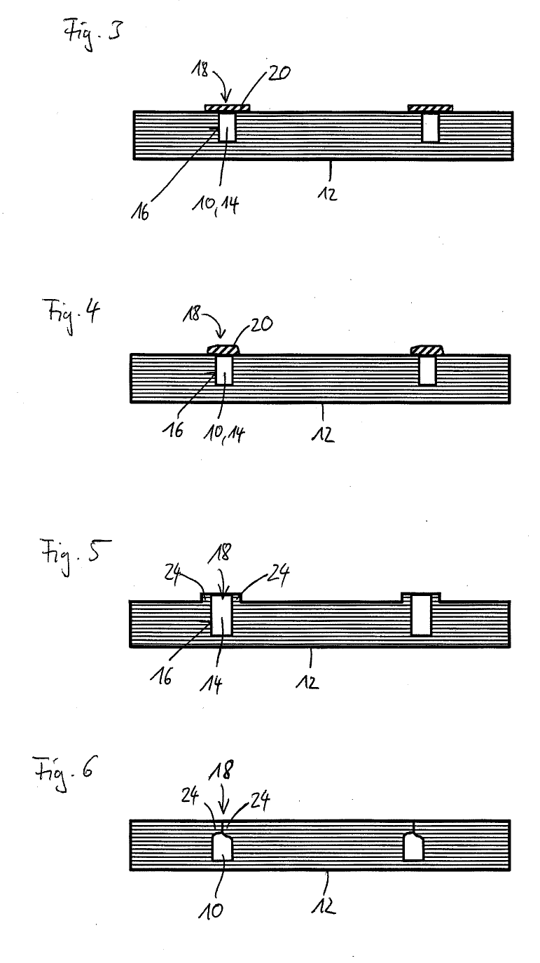

FIG. 4 shows an apparatus in accordance with a further embodiment of the invention which substantially corresponds to the embodiment shown in FIG. 3. The sealing element 20 is formed by a sealing material which is applied to the component 12 in liquid form, which has thereupon solidified, which enters into an active adhesive connection with the margin of the groove 14 at both sides of the groove 14 and which closed the groove 14 in a fluid-tight manner to form the passage 10. The sealing element 20 can be a silicone bead which has solidified, for example.

FIG. 5 shows a component 12 which is suitable for carrying out a method in accordance with an embodiment of the invention. The component 21 comprises a groove 14 which is open along its longitudinal extent toward the side 18 and which can be manufactured by milling, for example. In the present embodiment, wall sections 24 are provided which are configured as raised relative to the adjacent regions of the component 12, whereby the carrying out of the method is facilitated. In principle, the method can, however, also be carried out using a component 12 whose groove margin forms a planar surface with the adjacent regions of the component 12.

In the course of the method, the wall sections 24 are deformed by pressure application such that they come to contact one another in a fluid-sealing manner so that the groove is closed at its open side and a passage 10 is created which is closed in a fluid-tight manner (FIG. 6).

FIG. 6 shows the apparatus manufactured in this manner from the component 12 of FIG. 5. The wall sections 24 contact one another under a preload which is effected by a mutual elastic deformation of the wall sections 24 and thereby form a sealing element 20 which closes the passage 10 in a fluid-tight manner.

What is claimed is:

1. An apparatus having at least one passage (10) for conducting a gaseous or a liquid operating medium, wherein the passage (10) is closed in a fluid-tight manner at a side (18) by at least one elongate sealing element (20), the elongate sealing element being arranged to follow the extent of the passage (10).

2. The apparatus in accordance with claim 1, wherein the sealing element (20) is configured as at least one of elastically deformable at least regionwise and plastically deformable at least regionwise.

3. The apparatus in accordance with claim 1, wherein the passage (10) has a closed cross-section at least regionwise.

4. The apparatus in accordance with claim 1, wherein the sealing element (20) is formed by a separate sealing element which bounds the passage (10) together with a component (12) of the apparatus.

5. The apparatus in accordance with claim 4, wherein the component (12) has a groove (14) having a groove wall (16) and a groove margin, with at least one region of the groove (14) being closed by the sealing element (20), and with the passage (10) being formed by the closed region of the groove (14) and being bounded in a fluid-tight manner by the groove wall (16) and the sealing element (20).

6. The apparatus in accordance with claim 5, wherein the sealing element (20) is arranged within the groove (14) at least regionwise; and/or wherein the sealing element (20) covers the groove opening at least regionwise.

7. The apparatus in accordance with claim 5, wherein the sealing element (20) is connected to at least one member selected from the group comprising the groove wall (16) and the groove margin.

8. The apparatus in accordance with claim 7, wherein the sealing element (20) is connected to the at least one member by means of at least one of with material continuation, with force transmission and with form fitting.

9. The apparatus in accordance with claim 5, wherein the sealing element (20) is connected in a fluid-tight manner to at least one of the groove wall (16) and the groove margin.

10. The apparatus in accordance with claim 5, wherein the sealing element (20) is clamped in the groove (14) at least regionwise.

11. The apparatus in accordance with claim 5, wherein the component (12) has at least one cut-out (22) which is formed in the groove wall (16) and into which the sealing element (20) engages.

12. The apparatus in accordance with claim 4, wherein the sealing element (20) has a cross-sectional shape selected from the group of members comprising a circular cross-sectional shape, an oval cross-sectional shape, a cross-sectional shape closed in ring shape and an elongated cross-sectional shape at least over a part of its length perpendicular to its longitudinal direction.

13. The apparatus in accordance with claim 4, wherein the sealing element (20) is formed by at least one member selected from the group comprising an O ring, a sealing strip, a tube and a sheet metal section.

14. The apparatus in accordance with claim 1, wherein the sealing element (20) is formed by wall sections (24) of a component (12) which bound the passage (10) and which are brought into contact with one another by deformation.

15. The apparatus in accordance with claim 1, wherein at least one of the sealing element (20) and the passage (10) is formed in ring shape.

16. The apparatus in accordance with claim 1, wherein the passage (10) has at least one longitudinal end.

17. The apparatus in accordance with claim 16, wherein the passage (10) is closed in a fluid-tight manner at the longitudinal end by the sealing element (20).

18. The apparatus in accordance with claim 1, wherein the apparatus is one of a vacuum pump and a component of a vacuum pump.

19. A method of manufacturing an apparatus having at least one passage (10) for conducting a gaseous or a liquid operating medium, the method comprising the step of:
providing a component (12) with a groove (14) with the groove opening being closed in a fluid-tight manner by an elongated sealing element (20) following the extent of the groove (14) to form the passage (10).

20. The method in accordance with claim 19, further comprising the steps of closing off the at least one passage in a fluid-tight manner at a side (18) by the at least one elongate sealing element (20), and arranging the elongate sealing element to follow the extent of the passage (10).

21. The method in accordance with claim 19, further comprising the step of:
providing the component (12) with one of a separate sealing element (20) and a sealing material which is solidified to form a separate sealing element (20); or the step of:
bringing sections (24) of the component (12) into contact with one another by deformation to form the sealing element (20).
